(19) United States
(12) Patent Application Publication
(10) Pub. No.: US 2026/0236364 A1
(43) Pub. Date: Aug. 13, 2026

(54) MANAGEMENT OF DIAGNOSTIC OPERATIONS AT AN INFORMATION HANDLING SYSTEM

(71) Applicant: Dell Products L.P., Round Rock, TX (US)

(72) Inventors: Laxmi Lavanya Medicherla, Georgetown, TX (US); Ibrahim Sayyed, Georgetown, TX (US); Alan Helmy Abdelhalim, Pflugerville, TX (US)

(21) Appl. No.: 19/052,593

(22) Filed: Feb. 13, 2025

(51) Int. Cl. G06F 11/273; G06F 11/22; G06F 11/32

(52) U.S. Cl. CPC G06F 11/2733; G06F 11/2236; G06F 11/327

(57) ABSTRACT

Management of diagnostic operations at an IHS, including identifying a diagnostic test to be performed at the IHS, the diagnostic test including a sequence of interactive and non-interactive portions, the interactive portions to be interacted with by a user of the IHS; performing the diagnostic test at the information handling system, including performing an interactive portion of the diagnostic test; determining that the user is not present with respect to the ISH when performing the diagnostic test at the IHS, and in response: marking the interactive portion of the diagnostic test as incomplete and adding the interactive portion to a separate queue; identifying a subsequent portion of the diagnostic test based on the sequence of interactive and non-interactive portions of the diagnostic test; determining that the subsequent portion of the diagnostic test is a non-interactive portion, and in response, performing the non-interactive portion of the diagnostic test at the IHS.

### BACKGROUND

### Field of the Disclosure

The disclosure relates generally to an information handling system, and in particular, management of diagnostic operations at the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Diagnostic testing in computers involves running a series of tests to identify hardware or software issues. These tests can check components like the CPU, memory, hard drives, and other peripherals to ensure they are functioning correctly.

### SUMMARY

Innovative aspects of the subject matter described in this specification may be embodied in a method of management of diagnostic operations at an information handling system, including identifying a diagnostic test to be performed at the information handling system, the diagnostic test including a sequence of interactive and non-interactive portions, the interactive portions to be interacted with by a user of the information handling system; performing the diagnostic test at the information handling system, including performing an interactive portion of the diagnostic test; determining that the user is not present with respect to the information handling system when performing the diagnostic test at the information handling system, and in response: marking the interactive portion of the diagnostic test as incomplete and adding the interactive portion to a separate queue; identifying a subsequent portion of the diagnostic test based on the sequence of interactive and non-interactive portions of the diagnostic test; and determining that the subsequent portion of the diagnostic test is a non-interactive portion, and in response, performing the non-interactive portion of the diagnostic test at the information handling system.

Other embodiments of these aspects include corresponding systems, apparatus, and computer programs, configured to perform the actions of the methods, encoded on computer storage devices.

These and other embodiments may each optionally include one or more of the following features. For instance, after performing the non-interactive portion of the diagnostic test, determining that there is a further subsequent portion of the diagnostic test based on the sequence of interactive and non-interactive portions of the diagnostic test; and determining that the further subsequent portion of the diagnostic test is a subsequent non-interactive portion, and in response, performing the subsequent non-interactive portion of the diagnostic test at the information handling system. After performing the non-interactive portion of the diagnostic test, determining that there is a further subsequent portion of the diagnostic test based on the sequence of interactive and non-interactive portions of the diagnostic test; and determining that the further subsequent portion of the diagnostic test is a subsequent interactive portion, and in response, marking the subsequent interactive portion of the diagnostic test as incomplete and adding the subsequent interactive portion to a separate queue. After performing the non-interactive portion of the diagnostic test, determining that there are no further subsequent portions of the diagnostic test based on the sequence of interactive and non-interactive portions of the diagnostic test; in response to determining that there are no further subsequent portions of the diagnostic test, determining that the user is present with respect to the information handling system; and in response to determining that the user is present with respect to the information handling system, performing the interactive portions of the separate queue. After performing the non-interactive portion of the diagnostic test, determining that there are no further subsequent portions of the diagnostic test based on the sequence of interactive and non-interactive portions of the diagnostic test; and in response to determining that there are no further subsequent portions of the diagnostic test, determining that the user is not present with respect to the information handling system; in response to determining that the user is not present with respect to the information handling system, determining that a non-interactive version of the interactive portion of the separate queue is available; and in response to determining that a non-interactive version of the interactive portion of the separate queue is available, performing the non-interactive version of the interactive portion of the separate queue. After performing the non-interactive portion of the diagnostic test, determining that there are no further subsequent portions of the diagnostic test based on the sequence of interactive and non-interactive portions of the diagnostic test; in response to determining that there are no further subsequent portions of the diagnostic test, determining that the user is not present with respect to the information handling system; in response to determining that the user is not present with respect to the information handling system, determining that a non-interactive version of the interactive portion of the separate queue is not available; and in response to determining that a non-interactive version of the interactive portion of the separate queue is not available, placing the diagnostic test on hold for a time period and attempting to complete the diagnostic test at a later time. Determining the user is present with respect to the information handling system, and in response, performing the interactive portion of the diagnostic test. Performing the diagnostic test at the information handling system, including performing a non-interactive portion of the diagnostic test before performing the interactive portion of the diagnostic test. Determining that the subsequent portion of the diagnostic test is an interactive portion; in response to determining that the subsequent portion of the diagnostic test is a subsequent interactive portion, determining that the user is not present with respect to the information handling system; and in response to determining that the user is not present with respect to the information handling system, marking the subsequent interactive portion of the diagnostic test as incomplete and adding the subsequent interactive portion to the separate queue. Determining that the user is present with respect to the information handling system, and in response, determining that the user is inattentive to the information handling system; and in response to determining that the user is inattentive to the information handling system, providing a notification at the information handling system. The notification includes an audible notification.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for management of diagnostic operations.

FIG. 3 illustrates a method for management of diagnostic operations at an information handling system.

### DESCRIPTION OF PARTICULAR EMBODIMENT(S)

This disclosure discusses methods and systems for management of diagnostic operations at an information handling system. In short, the information handling system can perform a diagnostic test that includes interactive portions that require user input to proceed. When a user is absent from the information handling system, the diagnostic testing can be delayed, causing the information handling system to wait indefinitely for the user. The present invention addresses such a situation by moving past the interactive portion and storing such in a separate queue for later addressing by the user (when they arrive back), finding non-interactive versions of the interactive portions, and/or notifying the user that attention is needed at the information handling system, described further herein.

Specifically, this disclosure discusses a system and a method of management of diagnostic operations at an information handling system, including identifying a diagnostic test to be performed at the information handling system, the diagnostic test including a sequence of interactive and non-interactive portions, the interactive portions to be interacted with by a user of the information handling system; performing the diagnostic test at the information handling system, including performing an interactive portion of the diagnostic test; determining that the user is not present with respect to the information handling system when performing the diagnostic test at the information handling system, and in response: marking the interactive portion of the diagnostic test as incomplete and adding the interactive portion to a separate queue; identifying a subsequent portion of the diagnostic test based on the sequence of interactive and non-interactive portions of the diagnostic test; and determining that the subsequent portion of the diagnostic test is a non-interactive portion, and in response, performing the non-interactive portion of the diagnostic test at the information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

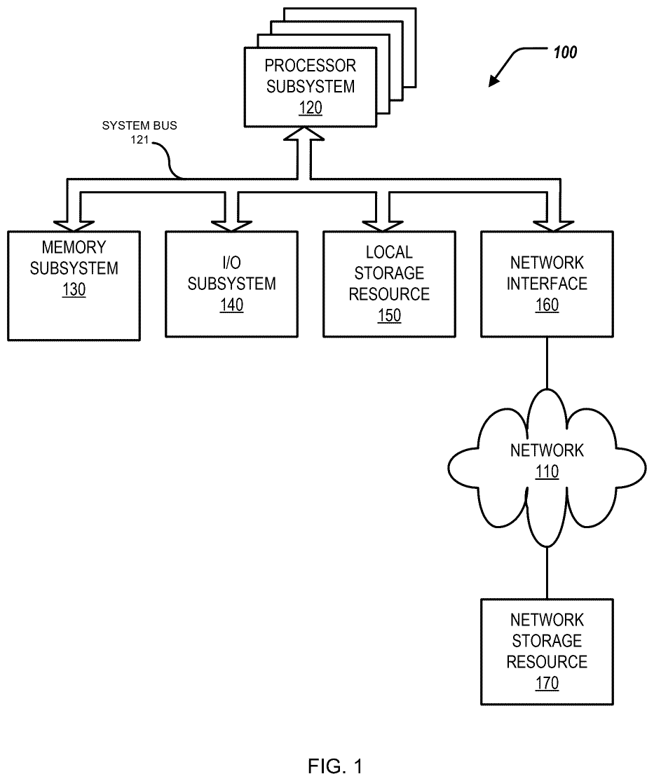

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

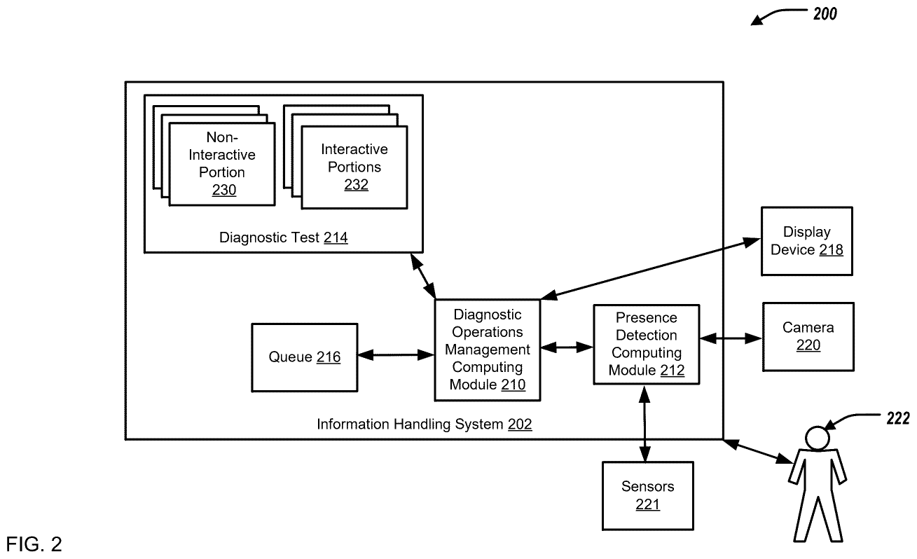

Turning to FIG. 2, FIG. 2 illustrates an environment 200 including an information handling system 202. The information handling system 202 can include a diagnostic operations management computing module 210, a presence detection computing module 212, and a queue 216. The environment 200 can further include a display device 218, a camera 220, and (presence) sensors 221. In some examples, the information handling system 202 is similar to, or includes, the information handling system 100 of FIG. 1.

The diagnostic operations management computing module 210 can be in communication with queue 216, the presence detection computing module 212, and the display device 218. The presence detection computing module 212 can be in communication with the diagnostic operations management computing module 210, the camera 220, and the sensors 221.

In short, the information handling system 202 can perform a diagnostic test that includes interactive portions that require user input to proceed. When a user is absent from the information handling system 202, the diagnostic testing can be delayed causing the information handling system 202 to wait indefinitely for the user. The present invention addresses such a situation by moving past the interactive portion and storing such in a separate queue for later addressing by the user (when they arrive back), finding non-interactive versions of the interactive portions, and/or notifying the user that attention is needed at the information handling system 202, described further herein.

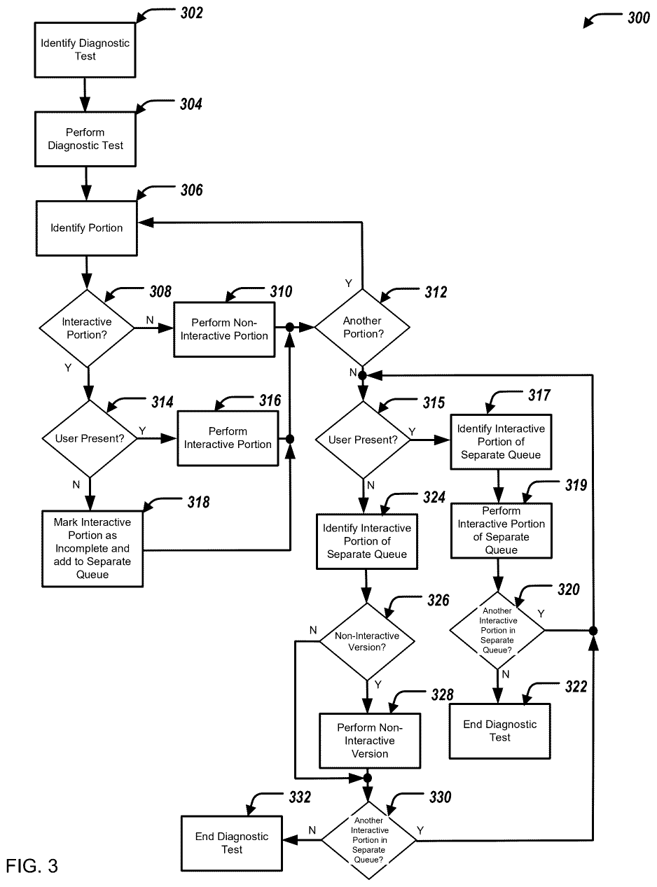

FIG. 3 illustrates a flowchart depicting selected elements of an embodiment of a method 300 for management of diagnostic operations. The method 300 may be performed by the information handling system 100, the information handling system 202, the diagnostic operations management computing module 210, and/or the presence detection computing module 212, and with reference to FIGS. 1-2. It is noted that certain operations described in method 300 may be optional or may be rearranged in different embodiments.

The diagnostic operations management computing module 210 identifies the diagnostic test 214 to be performed at the information handling system 202, at 302. The diagnostic test 214 can include a sequence of interactive portions 232 and non-interactive portions 230. The diagnostic test 214 can include any number of interactive portions 232 and any number of non-interactive portions 230. The sequence of the portions of the diagnostic test 214 can be any combination of the interactive portions 232 and the non-interactive portions 230. In some examples, the non-interactive portions 230 include portions of the diagnostic test 214 where interaction by a user 222 (via input devices to the information handling system 202) is not needed to be completed. In some examples, the interactive portions 232 include portions of the diagnostic test 214 where interaction by the user 222 (via input devices to the information handling system 202) is needed to be completed.

The diagnostic test 214 can test one or more features or one or more parameters of one or more computing modules or computing devices/components of the information handling system 202. For example, the diagnostic test 214 can include audible and/or visual portions for testing of the computing modules or computing devices/components of the information handling system 202. The diagnostic test 214 can include testing of memory, hard drives, processors and the like of the information handling system 202. The diagnostic test 214 can be an automated computer program sequence that determines the operational status within the software, hardware, or any combination thereof in a computing device/component of the information handling system 202.

The diagnostic operations management computing module 210 performs the diagnostic test 214 at the information handling system 202, at 304. The diagnostic operations management computing module 210 identifies a portion of the diagnostic test 214 based on the sequence of interactive portions 232 and non-interactive portions 230 of the diagnostic test 214, at 306. The diagnostic operations management computing module 210 determines whether the identified portion of the diagnostic test 214 is an interactive portion, at 308.

In some cases, the diagnostic operations management computing module 210 determines that the identified portion of the diagnostic test 214 is an interactive portion (at 308), and in response, the diagnostic operations management computing module 210 determines whether the user 222 is present with respect to the information handling system 202 when performing the diagnostic test 214 at the information handling system 202, at 314. In some examples, the presence detection computing module 212 determines whether the user 222 is present with respect to the information handling system 202 and provides a signal/data indicating such to the diagnostic operations management computing module 210. In some examples, the presence detection computing module 212 determines the presence of the user 222 with respect to the information handling system 202 utilizing the camera 220 and/or the (presence) sensors 221. For example, the presence detection computing module 212 can leverage the camera 220 and the sensors 221 (e.g., eye tracking and attention computing technology) to determine the presence of the user 222 with respect to the information handling system 202, and/or if the user 222 is able to interact with the interactive portion 232 of the diagnostic test 214 (provide input via input devices to the information handling system 202).

In some examples, the presence detection computing module 212 determines that the user 222 is not present with respect to the information handling system 202 (at 314), and provides a data/signal to the diagnostic operations management computing module 210 indicating such. The diagnostic operations management computing module 210, in response to such, marks the interactive portion 232 of the diagnostic test 214 as incomplete and adds the interactive portion 232 to a separate queue 216, at 318. That is, the diagnostic operations management computing module 210 populates the queue 216 with data indicating the interactive portion 232 that was unable to be completed.

The diagnostic operations management computing module 210, after marking the interactive portion 232 as incomplete and adding it to the queue 216, determines whether there is a further subsequent portion of the diagnostic test 214 based on the sequence of interactive portions 232 and non-interactive portions 230, at 312. In some examples, the diagnostic operations management computing module 210 determines that there is at least a subsequent portion of the diagnostic test 214 (at 312), and in response, the diagnostic operations management computing module 210 identifies a subsequent portion of the diagnostic test 214 based on the sequence of interactive portions 232 and non-interactive portions 230 of the diagnostic test 214, at 306.

The diagnostic operations management computing module 210 determines whether the subsequent portion of the diagnostic test 214 is an interactive portion, at 308. In some cases, the diagnostic operations management computing module 210 determines that the subsequent portion of the diagnostic test 214 is not an interactive portion (that is, the portion is a non-interactive portion 230) (at 308), and in response, the diagnostic operations management computing module 210 performs the non-interactive portion 230 of the diagnostic test 214 at the information handling system 202, at 310. The method proceeds to step 312.

In some examples, the presence detection computing module 212 determines that the user 222 is present with respect to the information handling system 202 (at 314), and provides a data/signal to the diagnostic operations management computing module 210 indicating such. The diagnostic operations management computing module 210, in response to such, performs the interactive portion 232 of the diagnostic test 214, at 316. For example, the user 222 interacts with the information handling system 202 (via input devices such as a keyboard, a mouse, a touchscreen, and the like) to complete the interactive portion 232 of the diagnostic test 214. For example, for a diagnostic test of the speakers of the information handling system 202, the user 222 can listen to audio from the speakers and provide input based on such audio to complete the interactive portion 232 of the diagnostic test 214. For example, for a diagnostic test of the display device 218, a display driver, or the like, can display an alphanumeric character(s) on the display device 218 and the user 222 can provide input indicating the alphanumeric character(s) via a keyboard of the information handling system 202. The method can then proceed to step 312.

In some examples, the diagnostic operations management computing module 210 determines that there is at least a subsequent portion of the diagnostic test 214 (at 312), and in response, the diagnostic operations management computing module 210 identifies a subsequent portion of the diagnostic test 214 based on the sequence of interactive portions 232 and non-interactive portions 230 of the diagnostic test 214, at 306. The diagnostic operations management computing module 210 determines whether the subsequent portion of the diagnostic test 214 is an interactive portion, at 308. In some cases, the diagnostic operations management computing module 210 determines that the subsequent portion of the diagnostic test 214 is not an interactive portion (that is, the portion is a non-interactive portion 230) (at 308), and in response, the diagnostic operations management computing module 210 performs the subsequent non-interactive portion 230 of the diagnostic test 214 at the information handling system 202, at 310.

In some examples, the diagnostic operations management computing module 210 determines that there is at least a subsequent portion of the diagnostic test 214 (at 312), and in response, the diagnostic operations management computing module 210 identifies a subsequent portion of the diagnostic test 214 based on the sequence of interactive portions 232 and non-interactive portions 230 of the diagnostic test 214, at 306. The diagnostic operations management computing module 210 determines whether the subsequent portion of the diagnostic test 214 is an interactive portion, at 308. In some cases, the diagnostic operations management computing module 210 determines that the subsequent portion of the diagnostic test 214 is an interactive portion (at 308), and in response, the diagnostic operations management computing module 210 determines whether the user 222 is present with respect to the information handling system 202 when performing the diagnostic test 214 at the information handling system 202, at 314. In some examples, the presence detection computing module 212 determines whether the user 222 is present with respect to the information handling system 202 and provides a signal/data indicating such to the diagnostic operations management computing module 210. The presence detection computing module 212 determines that the user 222 is not present with respect to the information handling system 202 (at 314), and provides a data/signal to the diagnostic operations management computing module 210 indicating such. The diagnostic operations management computing module 210, in response to such, marks the subsequent interactive portion 232 of the diagnostic test 214 as incomplete and adds the subsequent interactive portion 232 to the queue 216, at 318. That is, the diagnostic operations management computing module 210 populates the queue 216 with data indicating the subsequent interactive portion 232 that was unable to be completed.

In some examples, the diagnostic operations management computing module 210 determines that there are no further subsequent portions of the diagnostic test 214 based on the sequence of the non-interactive portions 230 and the interactive portions 232 (at 312), and in response, the diagnostic operations management computing module 210 determines whether the user 222 is present with respect to the information handling system 202 when performing the diagnostic test 214 at the information handling system 202, at 315. In some examples, the presence detection computing module 212 determines whether the user 222 is present with respect to the information handling system 202 and provides a signal/data indicating such to the diagnostic operations management computing module 210. In some examples, the presence detection computing module 212 determines the presence of the user 222 with respect to the information handling system 202 utilizing the camera 220 and/or the (presence) sensors 221. For example, the presence detection computing module 212 can leverage the camera 220 and the sensors 221 (e.g., eye tracking and attention computing technology) to determine the presence of the user 222 with respect to the information handling system 202, and/or if the user 222 is able to interact with the interactive portion 232 of the diagnostic test 214. In some cases, the presence detection computing module 212 determines that the user 222 is present with respect to the information handling system 202 (at 315), and the diagnostic operations management computing module 210 identifies an interactive portion 232 of the diagnostic test 214 of the queue 216, at 317. The diagnostic operations management computing module 210 performs the interactive portion 232 of the queue 216, at 319. For example, the user 222 interacts with the information handling system 202 (via input devices such as a keyboard, a mouse, a touchscreen, and the like) to complete the interactive portion 232 of the queue 216. For example, for a diagnostic test 214 of the speakers of the information handling system 202, the user 222 can listen to audio from the speakers and provide input based on such audio to complete the interactive portion 232 of the queue 216. For example, for a diagnostic test 214 of the display device 218, a display driver, or the like, can display an alphanumeric character(s) on the display device 218 and the user 222 can provide input indicating the alphanumeric character(s) via a keyboard of the information handling system 202.

The diagnostic operations management computing module 210 determines whether there is a further interactive portion of the queue 216, at 320. In some examples, the diagnostic operations management computing module 210 determines that there is a further interactive portion of the queue 216 (at 320), and in response, returns to step 315. In some examples, the diagnostic operations management computing module 210 determines that there is not a further interactive portion of the queue 216 (at 320), and in response, the diagnostic test 214 ends, at 322.

In some cases, the presence detection computing module 212 determines that the user 222 is not present with respect to the information handling system 202 (at 315), and in response, the diagnostic operations management computing module 210 identifies an interactive portion 232 of the diagnostic test 214 of the queue 216, at 324. The diagnostic operations management computing module 210 determines whether there is a non-interactive version of the interactive portion 232 of the queue 216 available, at 326. The non-interactive version of the interactive portion 232 can be performed without interaction by the user 222 while achieving the same intention of the interactive portion 232. For example, for an audio-based interactive portion 232, the non-interactive version of the audio-based interactive portion 232 can be available. For example, the non-interactive version of the interactive portion 232 can be completed without input needed from the user 222.

In some examples, the diagnostic operations management computing module 210 determines that there is a non-interactive version of the interactive portion 232 of the queue 216 available (at 326), and in response, the diagnostic operations management computing module 210 performs the non-interactive version of the interactive portion 232 of the queue 216 at the information handling system 202, at 328. The diagnostic operations management computing module 210 determines whether there is a further interactive portion of the queue 216, at 330. In some examples, the diagnostic operations management computing module 210 determines that there is a further interactive portion of the queue 216 (at 330), and in response, returns to step 315. In some examples, the diagnostic operations management computing module 210 determines that there is not a further interactive portion of the queue 216 (at 330), and in response, the diagnostic test 214 ends, at 332.

In some examples, the diagnostic operations management computing module 210 determines that there is not a non-interactive version of the interactive portion 232 of the queue 216 available (at 326), and in response, the diagnostic operations management computing module 210 proceeds to step 330. In some examples, the diagnostic operations management computing module 210 can place the diagnostic test 214 on hold for a time period and attempts to complete the diagnostic test 214 at a later time.

In some further examples, determining, by the diagnostic operations management computing module 210, that the user 222 is present with respect to the information handling system 202 (as in steps 314, 315) can further include determining whether the user 222 is inattentive to the information handling system 202. Specifically, when it is determined that the user 222 is present with respect to the information handling system 202, the diagnostic operations management computing module 210 can further determine whether the user 222 is inattentive to the information handling system 202.

In some examples, the presence detection computing module 212 determines the attentiveness of the user 222 with respect to the information handling system 202 utilizing the camera 220 and/or the (presence) sensors 221. For example, the presence detection computing module 212 can leverage the camera 220 and the sensors 221 (e.g., eye tracking and attention computing technology) to determine the attentiveness of the user 222 with respect to the information handling system 202, and/or if the user 222 is able to interact with the interactive portion 232 of the diagnostic test 214. The presence detection computing module 212 can determine the attentiveness of the user 222 by determining an eye gaze of the user 222 with respect to the display device 218. In some examples, when the presence detection computing module 212 determines that the user 222 is attentive to the information handling system 202, the diagnostic operations management computing module 210 can determine that the user 222 is present with respect to the information handling system 202 (at steps 314, 315).

In some examples, when the presence detection computing module 212 determines that the user 222 is inattentive to the information handling system 202, the diagnostic operations management computing module 210 can provide a notification at the information handling system 202. For example, the notification can include an audible notification to gain the attention of the user 222. For example, the notification can be provided to a third party computing device associated with the user 222 (e.g., such as a mobile device).

In a use case example, the user starts a scheduled diagnostic test that includes a set of non-interactive portions and interactive portions. The user physically leaves the information handling system. When an interactive portion of the diagnostic test is next in the sequence, the information handling system detects that the user is not present, and adds the interactive portion of the diagnostic test to the “retry later” queue and moves to the next portion of the diagnostic test. When all non-interactive portions are complete, the information handling system waits on the user to return to resume execution of the queue of the interactive tests.

In a use case example, the user starts a scheduled diagnostic test that includes a set of non-interactive portions and interactive portions. The user physically leaves the information handling system. When an interactive portion of the diagnostic test is next in the sequence, the information handling system detects the user is not present, and the information handling system falls back to a non-interactive version of the interactive portion to continue the diagnostic testing.

In a use case example, the user starts a scheduled diagnostic test that includes a set of non-interactive portions and interactive portions. The user is physically present at the information handling system but inattentive. The information handling system detects such inattentiveness of the user, and emits an audio beep, sends a text message, or the like to gain the attentiveness of the user such that the user can provide the necessary input for an interactive portion of the diagnostic test.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of management of diagnostic operations at an information handling system, comprising:
identifying a diagnostic test to be performed at the information handling system, the diagnostic test including a sequence of interactive and non-interactive portions, the interactive portions to be interacted with by a user of the information handling system;
performing the diagnostic test at the information handling system, including performing an interactive portion of the diagnostic test;
determining that the user is not present with respect to the information handling system when performing the diagnostic test at the information handling system, and in response:
marking the interactive portion of the diagnostic test as incomplete and adding the interactive portion to a separate queue;
identifying a subsequent portion of the diagnostic test based on the sequence of interactive and non-interactive portions of the diagnostic test; and
determining that the subsequent portion of the diagnostic test is a non-interactive portion, and in response, performing the non-interactive portion of the diagnostic test at the information handling system.

2. The computer-implemented method of claim 1, further including:
after performing the non-interactive portion of the diagnostic test, determining that there is a further subsequent portion of the diagnostic test based on the sequence of interactive and non-interactive portions of the diagnostic test; and
determining that the further subsequent portion of the diagnostic test is a subsequent non-interactive portion, and in response, performing the subsequent non-interactive portion of the diagnostic test at the information handling system.

3. The computer-implemented method of claim 1, further including:
after performing the non-interactive portion of the diagnostic test, determining that there is a further subsequent portion of the diagnostic test based on the sequence of interactive and non-interactive portions of the diagnostic test; and
determining that the further subsequent portion of the diagnostic test is a subsequent interactive portion, and in response, marking the subsequent interactive portion of the diagnostic test as incomplete and adding the subsequent interactive portion to a separate queue.

4. The computer-implemented method of claim 1, further including:
after performing the non-interactive portion of the diagnostic test, determining that there are no further subsequent portions of the diagnostic test based on the sequence of interactive and non-interactive portions of the diagnostic test;
in response to determining that there are no further subsequent portions of the diagnostic test, determining that the user is present with respect to the information handling system; and
in response to determining that the user is present with respect to the information handling system, performing the interactive portions of the separate queue.

5. The computer-implemented method of claim 1, further including:
after performing the non-interactive portion of the diagnostic test, determining that there are no further subsequent portions of the diagnostic test based on the sequence of interactive and non-interactive portions of the diagnostic test; and
in response to determining that there are no further subsequent portions of the diagnostic test, determining that the user is not present with respect to the information handling system;
in response to determining that the user is not present with respect to the information handling system, determining that a non-interactive version of the interactive portion of the separate queue is available; and
in response to determining that a non-interactive version of the interactive portion of the separate queue is available, performing the non-interactive version of the interactive portion of the separate queue.

6. The computer-implemented method of claim 1, further including:
after performing the non-interactive portion of the diagnostic test, determining that there are no further subsequent portions of the diagnostic test based on the sequence of interactive and non-interactive portions of the diagnostic test;
in response to determining that there are no further subsequent portions of the diagnostic test, determining that the user is not present with respect to the information handling system;
in response to determining that the user is not present with respect to the information handling system, determining that a non-interactive version of the interactive portion of the separate queue is not available; and
in response to determining that a non-interactive version of the interactive portion of the separate queue is not available, placing the diagnostic test on hold for a time period and attempting to complete the diagnostic test at a later time.

7. The computer-implemented method of claim 1, further including:
determining the user is present with respect to the information handling system, and in response, performing the interactive portion of the diagnostic test.

8. The computer-implemented method of claim 1, further including:
performing the diagnostic test at the information handling system, including performing a non-interactive portion of the diagnostic test before performing the interactive portion of the diagnostic test.

9. The computer-implemented method of claim 1, further including:
determining that the subsequent portion of the diagnostic test is an interactive portion;
in response to determining that the subsequent portion of the diagnostic test is a subsequent interactive portion, determining that the user is not present with respect to the information handling system; and
in response to determining that the user is not present with respect to the information handling system, marking the subsequent interactive portion of the diagnostic test as incomplete and adding the subsequent interactive portion to the separate queue.

10. The computer-implemented method of claim 1, further including:
determining that the user is present with respect to the information handling system, and in response, determining that the user is inattentive to the information handling system; and
in response to determining that the user is inattentive to the information handling system, providing a notification at the information handling system.

11. The computer-implemented method of claim 10, wherein the notification includes an audible notification.

12. An information handling system comprising a processor having access to memory media storing instructions executable by the processor to perform operations, comprising:
identifying a diagnostic test to be performed at the information handling system, the diagnostic test including a sequence of interactive and non-interactive portions, the interactive portions to be interacted with by a user of the information handling system;
performing the diagnostic test at the information handling system, including performing an interactive portion of the diagnostic test;
determining that the user is not present with respect to the information handling system when performing the diagnostic test at the information handling system, and in response:
marking the interactive portion of the diagnostic test as incomplete and adding the interactive portion to a separate queue;
identifying a subsequent portion of the diagnostic test based on the sequence of interactive and non-interactive portions of the diagnostic test; and
determining that the subsequent portion of the diagnostic test is a non-interactive portion, and in response, performing the non-interactive portion of the diagnostic test at the information handling system.

13. The information handling system of claim 12, the operations further including:
after performing the non-interactive portion of the diagnostic test, determining that there is a further subsequent portion of the diagnostic test based on the sequence of interactive and non-interactive portions of the diagnostic test; and
determining that the further subsequent portion of the diagnostic test is a subsequent non-interactive portion, and in response, performing the subsequent non-interactive portion of the diagnostic test at the information handling system.

14. The information handling system of claim 12, the operations further including:
after performing the non-interactive portion of the diagnostic test, determining that there is a further subsequent portion of the diagnostic test based on the sequence of interactive and non-interactive portions of the diagnostic test; and
determining that the further subsequent portion of the diagnostic test is a subsequent interactive portion, and in response, marking the subsequent interactive portion of the diagnostic test as incomplete and adding the subsequent interactive portion to a separate queue.

15. The information handling system of claim 12, the operations further including:
after performing the non-interactive portion of the diagnostic test, determining that there are no further subsequent portions of the diagnostic test based on the sequence of interactive and non-interactive portions of the diagnostic test;
in response to determining that there are no further subsequent portions of the diagnostic test, determining that the user is present with respect to the information handling system; and
in response to determining that the user is present with respect to the information handling system, performing the interactive portions of the separate queue.

16. The information handling system of claim 12, the operations further including:
after performing the non-interactive portion of the diagnostic test, determining that there are no further subsequent portions of the diagnostic test based on the sequence of interactive and non-interactive portions of the diagnostic test; and
in response to determining that there are no further subsequent portions of the diagnostic test, determining that the user is not present with respect to the information handling system;
in response to determining that the user is not present with respect to the information handling system, determining that a non-interactive version of the interactive portion of the separate queue is available; and
in response to determining that a non-interactive version of the interactive portion of the separate queue is available, performing the non-interactive version of the interactive portion of the separate queue.

17. The information handling system of claim 12, the operations further including:
after performing the non-interactive portion of the diagnostic test, determining that there are no further subsequent portions of the diagnostic test based on the sequence of interactive and non-interactive portions of the diagnostic test;
in response to determining that there are no further subsequent portions of the diagnostic test, determining that the user is not present with respect to the information handling system;
in response to determining that the user is not present with respect to the information handling system, determining that a non-interactive version of the interactive portion of the separate queue is not available; and
in response to determining that a non-interactive version of the interactive portion of the separate queue is not available, placing the diagnostic test on hold for a time period and attempting to complete the diagnostic test at a later time.

18. The information handling system of claim 12, the operations further including:
determining the user is present with respect to the information handling system, and in response, performing the interactive portion of the diagnostic test.

19. The information handling system of claim 12, the operations further including:
performing the diagnostic test at the information handling system, including performing a non-interactive portion of the diagnostic test before performing the interactive portion of the diagnostic test.

20. A non-transitory computer-readable medium storing software comprising instructions executable by one or more computers which, upon such execution, cause the one or more computers to perform operations comprising:
identifying a diagnostic test to be performed at the information handling system, the diagnostic test including a sequence of interactive and non-interactive portions, the interactive portions to be interacted with by a user of the information handling system;
performing the diagnostic test at the information handling system, including performing an interactive portion of the diagnostic test;
determining that the user is not present with respect to the information handling system when performing the diagnostic test at the information handling system, and in response:
marking the interactive portion of the diagnostic test as incomplete and adding the interactive portion to a separate queue;
identifying a subsequent portion of the diagnostic test based on the sequence of interactive and non-interactive portions of the diagnostic test; and
determining that the subsequent portion of the diagnostic test is a non-interactive portion, and in response, performing the non-interactive portion of the diagnostic test at the information handling system.
